(19) United States
(12) Patent Application Publication
(10) Pub. No.: US 2024/0046923 A1
(43) Pub. Date: Feb. 8, 2024

(54) METHOD AND SYSTEM FOR PROACTIVE INTERACTION

(71) Applicant: SoundHound, Inc., Santa Clara, CA (US)

(72) Inventor: Masaki NAITO, Nagano (JP)

(73) Assignee: SoundHound, Inc., Santa Clara, CA (US)

(21) Appl. No.: 18/361,791

(22) Filed: Jul. 28, 2023

(30) Foreign Application Priority Data
Aug. 2, 2022 (JP) 2022-123426

(51) Int. Cl. G10L 15/19; G06F 16/245; G10L 15/22; G10L 15/30

(52) U.S. Cl. CPC G10L 15/19; G06F 16/245; G10L 15/22; G10L 15/30

(57) ABSTRACT

In an interaction system, a server can obtain a setting expression including a query and a condition for functioning as a virtual assistant, store the query and the condition in a memory, and deliver an inquiry expression including the query in response to occurrence of a situation specified by the condition. The setting expression can be by voice or natural language. Processes can be different for different users and can be based on domain. The inquiry expression includes a question asking the user for an affirmative response before performing the inquiry. Implementations can be adopted in or near a vehicle.

### RELATED APPLICATIONS

This application is a Non-provisional Application under 35 USC § 111(a), which claims priority to Japan Patent Application Serial No. 2022-123426, filed Aug. 2, 2022, the disclosure of all of which is hereby incorporated by reference in its entirety.

### BACKGROUND

Proactive operations by a virtual assistant have conventionally been discussed. For example, NPL 1 (Maria Schmidt et al., “How Users React to Proactive Voice Assistant Behavior While Driving,” [online], May 11, 2020, [Searched on Jun. 13, 2022], the Internet <URL: https://aclanthology.org/2020.1rec-1.61/>) discusses the magnitude of driver's cognitive load imposed by non-proactive operations and proactive operations by a virtual assistant. NPL 2 (O. Miksik et al, “Building Proactive Voice Assistants: When and How (not) to Interact,” [online], May 4, 2020 [Searched on Jun. 13, 2022], the Internet <URL: https://arxiv.org/pdf/2005.01322.pdf>) discusses appropriate timing to start proactive operations by a virtual assistant.

### SUMMARY OF THE INVENTION

According to one aspect of the present disclosure, a method of query processing is introduced, which involves obtaining a setting expression including a query and a condition. This query and condition are then stored in memory. Upon detecting a circumstance as defined by the condition, a proactive interaction can be initiated with an inquiry expression that includes the query.

### BRIEF DESCRIPTION OF THE DRAWINGS

FIG. 1 is a diagram showing an exemplary configuration of an interaction system in an embodiment.

FIG. 2 is a diagram schematically showing an exemplary operation of the interaction system 1.

FIG. 3 is a diagram showing an exemplary hardware configuration of a main server 100.

FIG. 4 is a diagram showing an exemplary hardware configuration of a user terminal 200.

FIG. 5 is a diagram showing exemplary contents in the registration information.

FIG. 6 is a diagram showing, together with a setting expression, a first specific example of a data structure of the registration information.

FIG. 7 is a diagram showing, together with a setting expression, a second specific example of the data structure of the registration information.

FIG. 8 is a diagram showing, together with a setting expression, a third specific example of the data structure of the registration information.

FIG. 9 is a diagram showing a first specific example of a data structure of a frame of a polling query.

FIG. 10 is a diagram showing a first specific example of a data structure of a polling query.

FIG. 11 is a diagram showing a second specific example of a data structure of a frame of a polling query.

FIG. 12 is a diagram showing a second specific example of a data structure of a polling query.

FIG. 13 is a diagram showing a third specific example of a data structure of a frame of a polling query.

FIG. 14 is a diagram showing a third specific example of a data structure of a polling query.

FIG. 15 is a diagram for illustrating a method of generating an inquiry expression.

FIG. 16 is a flowchart of processing performed by interaction system 1.

FIG. 17 is a flowchart of processing performed by interaction system 1.

FIG. 18 is a flowchart of processing performed by interaction system 1.

FIG. 19 is a flowchart of processing performed by interaction system 1.

### DETAILED DESCRIPTION

One embodiment of an interaction system that implements an interaction method will be described below with reference to the drawings. The same components and constituent elements in the description below have the same reference characters allotted and their labels and functions are also the same. Therefore, description thereof will not be repeated.

### 1. Configuration of Interaction System

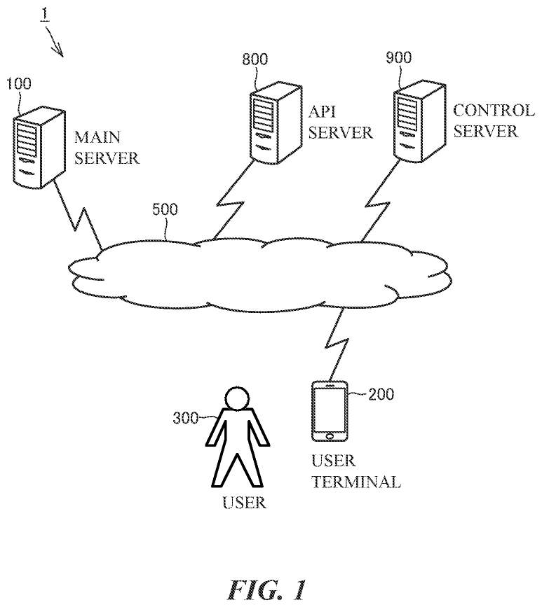

FIG. 1 is a diagram showing an exemplary configuration of an interaction system in an embodiment. An interaction system 1 includes a main server 100, a user terminal 200, an application programming interface (API) server 800, and a control server 900. Though a single main server 100, a single user terminal 200, a single API server 800, and a single control server 900 are provided in FIG. 1, the number of each of them is not restricted to one in a technique described in the present disclosure.

In interaction system 1, main server 100 and user terminal 200 each function as a virtual assistant for a user 300. A server application program (a server app.) for a function as a virtual assistant has been installed in main server 100. A terminal application program (a terminal app.) for a function as a virtual assistant has been installed in user terminal 200. User terminal 200 may be, for example, a smartphone, a smart speaker, an information processing apparatus mounted on a car, or an information processing apparatus mounted on a home electrical appliance.

In order to function as the virtual assistant, main server 100 transmits a request to API server 800, receives a response in accordance with the request from API server 800, and uses the received response, as necessary. In order to function as the virtual assistant, main server 100 transmits an instruction to control server 900, as necessary.

API server 800 is implemented, for example, as a server that provides information on weather. Control server 900 is implemented as a server that controls operations of various apparatuses. By way of example, control server 900 communicates with a computer mounted on a car to control operations of components (an air-conditioner, a radio, and the like) in the car. In another example, control server 900 communicates with a computer mounted on a home electrical appliance to control an operation of the home electrical appliance.

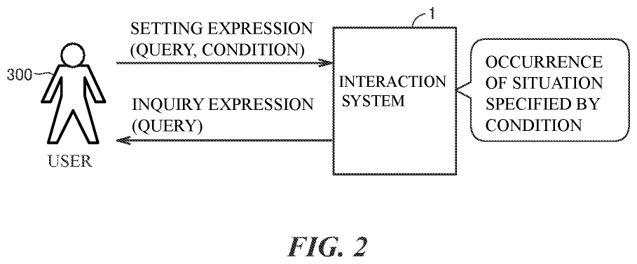

FIG. 2 is a diagram schematically showing an exemplary operation of interaction system 1. Interaction system 1 obtains a setting expression from user 300. The setting expression includes information specifying a query and a condition. Interaction system 1 monitors whether or not a situation specified by the condition occurs. When the situation specified by the condition occurs, interaction system 1 outputs an inquiry expression including a query. Thus, when the situation specified by the condition set by user 300 occurs, interaction system 1 can start a proactive interaction with user 300. Interaction system 1 can start such a proactive interaction with an inquiry expression including a query set by user 300.

### 2. Hardware Configuration (Main Server)

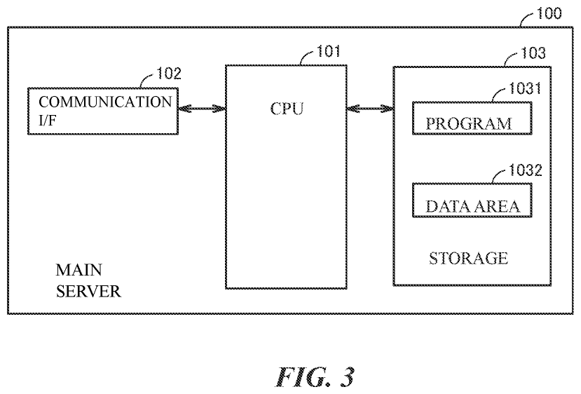

FIG. 3 is a diagram showing an exemplary hardware configuration of main server 100. Main server 100 includes a central processing unit (CPU) 101, a communication interface (I/F) 102, and a storage 103. Storage 103 includes a program area 1031 where various programs are stored and a data area 1032 where various types of data are stored. Though FIG. 1 shows that main server 100, user terminal 200, API server 800, and control server 900 communicate over network 500, they do not have to communicate over network 500. For example, both user terminal 200 and control server 900 may be mounted on a car, or user terminal 200 and control server 900 may be configured to directly communicate with each other.

CPU 101 performs various types of computation by executing a program stored in storage 103 or an external storage device. Communication I/F 102 is implemented, for example, by a network card, and allows main server 100 to communicate with another apparatus in interaction system 1. In interaction system 1, API server 800 and control server 900 may be similar in hardware configuration to main server 100 shown in FIG. 3.

### 3. Hardware Configuration (User Terminal)

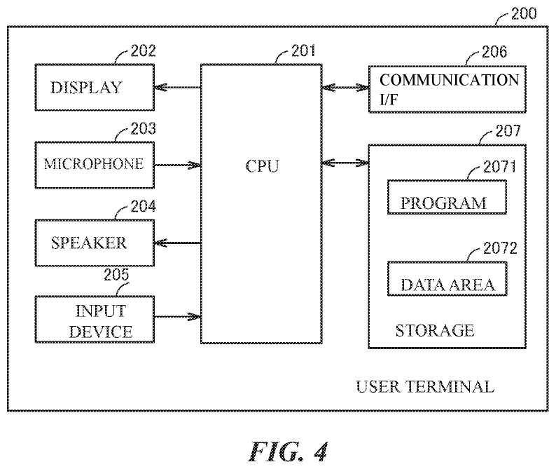

FIG. 4 is a diagram showing an exemplary hardware configuration of user terminal 200. User terminal 200 includes a CPU 201, a display 202, a microphone 203, a speaker 204, an input device 205, a communication I/F 206, and a storage 207. Storage 207 includes a program area 2071 where various programs are stored and a data area 2072 where various types of data are stored.

CPU 201 performs various types of computation by executing a program stored in storage 207 or an external storage device.

Display 202 shows a screen instructed by CPU 201. Microphone 203 provides inputted voice to CPU 201. Speaker 204 outputs voice instructed by CPU 201. Input device 205 is implemented, for example, by a physical key and/or a touch sensor and accepts input of information from the user. Communication I/F 206 is implemented, for example, by a network card, and allows user terminal 200 to communicate with another apparatus in interaction system 1.

### 4. Processing of Setting Expression

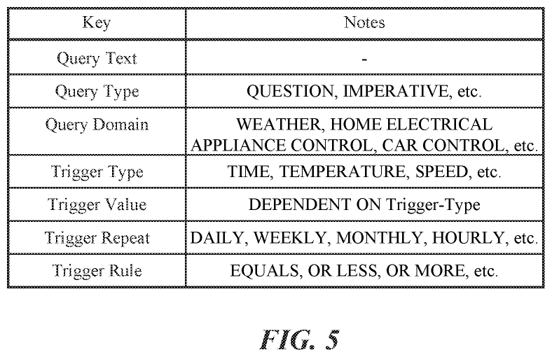

In interaction system 1, when main server 100 accepts a setting expression from the user, it extracts a query and a condition from the setting expression and has the query and the condition stored in storage 103 as registration information. Processing for extracting the query and the condition from the setting expression for storage as registration information will be described with reference to FIGS. 5 to 7.

### Contents of Registered Data

FIG. 5 is a diagram showing exemplary contents in registration information. As shown as “Key” in FIG. 5, stored data includes seven types of items (“Query Text,” “Query Type,” “Query Domain,” “Trigger Type,” “Trigger Value,” “Trigger Repeat,” and “Trigger Rule”). “Query Text,” “Query Type,” and “Query Domain” are information that defines a query. “Trigger Type,” “Trigger Value,” “Trigger Repeat,” and “Trigger Rule” are information that defines a condition. Each item will be described below.

“Query Text” identifies text of a query.

“Query Type” identifies a type of a query. In one implementation, a “question” and an “imperative” are defined as the type of the query. The “question” means a query expressing contents that the user wants to know. The “imperative” means a query expressing contents that the user desires to realize.

“Query Domain” identifies a domain to which a query belongs. In one implementation, the domain means a field expressed by contents in the query. FIG. 5 shows an example where “weather”, “home electrical appliance control,” and “car control” are shown as exemplary domains.

“Trigger Type” identifies a type of a condition. FIG. 5 shows an example in which “time”, a “temperature,” and a “speed” are shown as exemplary types of the condition.

“Trigger Value” identifies a value that defines a condition. A type of the value that defines the condition is dependent on a type of the condition (“Trigger Type”). For example, when “Trigger Type” indicates time, “Trigger Value” has a value corresponding to a unit of time, when “Trigger Type” indicates the temperature, “Trigger Value” has a value corresponding to a unit of temperature, and when “Trigger Type” indicates the speed, “Trigger Value” has a value corresponding to a unit of speed.

“Trigger Repeat” identifies a frequency of occurrence of a situation specified by the condition. FIG. 5 shows an example in which “daily,” “weekly (day of the week),” “monthly (xth),” and “hourly” are defined as the frequency of occurrence of the condition. As the registration information includes a value of the item “Trigger Repeat,” the condition included in the registration information defines the frequency of occurrence of the situation.

“Trigger Rule” identifies a rule under which “Trigger Value” is used. In one implementation, “equals”, “or more,” and “or less” are defined as the rule.

### First Specific Example of Registered Data

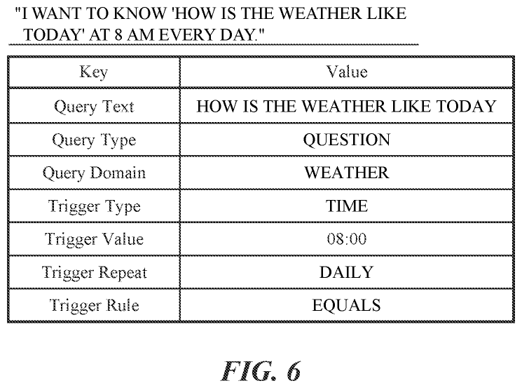

FIG. 6 is a diagram showing, together with a setting expression, a first specific example of a data structure of the registration information.

The data structure in FIG. 6 includes data that defines a query and a condition extracted from a setting expression “I want to know ‘how is the weather like today’ at 8 AM every day.”

More specifically, the data structure in FIG. 6 includes “how is the weather like today” as “Query Text.”

In one implementation, the setting expression is subjected to natural language interpretation so that a portion “how is the weather like today” that expresses the query is extracted from the setting expression as “Query Text.”

For example, grammar for natural language interpretation of the setting expression is stored in main server 100. An exemplary grammar is “I want to know [Second Phrase], [First Phrase].” In this grammar, each of [First Phrase] and [Second Phrase] intends to express any text. When the setting expression matches with this grammar, a portion corresponding to [First Phrase] is extracted as a portion expressing the query.

The data structure in FIG. 6 includes “question” as “Query Type.” In one implementation, when the setting expression includes a phrase “I want to know,” “question” is specified as the type of the query.

The data structure in FIG. 6 includes “weather” as “Query Domain.” In one implementation, after the query is extracted from the setting expression, grammar to which the query applies is specified and a domain to which the specified grammar belongs is specified. Such a specified domain is specified as the value of “Query Domain.” In interaction system 1, a database indicating a domain to which each of a plurality of grammars used for natural language interpretation belongs is stored, for example, in storage 103.

The data structure in FIG. 6 includes “time” as “Trigger Type.” In one implementation, after the query is extracted from the setting expression, a portion other than the query of the setting expression is subjected to natural language interpretation so that the value of “Trigger Type” is specified. For example, when the query includes a character string “at x” (“x” representing a number), “time” is specified as the value of “Trigger Type.”

The data structure in FIG. 6 includes “08:00” as “Trigger Value.” In one implementation, the value of “Trigger Value” is specified with the use of a phrase used for specifying the value of “Trigger Type.” More specifically, when the value “time” of “Trigger Type” is specified by inclusion of a phrase “at 8 AM” in the setting expression, a numeric value “08:00” corresponding to a portion “8 AM” expressing time that is included in the phrase is specified as the value of “Trigger Type.”

The data structure in FIG. 6 includes “daily” as “Trigger Repeat.” In one implementation, when a character string expressing the frequency is included in a portion other than the query of the setting expression, the character string is specified as “Trigger Repeat.”

The data structure in FIG. 6 includes “equals” as “Trigger Rule.” In one implementation, the value of “Trigger Value” is specified with the use of the phrase used for specifying the value of “Trigger Type.” In the example in FIG. 6, since the phrase “at 8 AM” indicates “8 AM” itself that expresses time, “equals” is specified as “Trigger Rule.”

### Second Specific Example of Registered Data

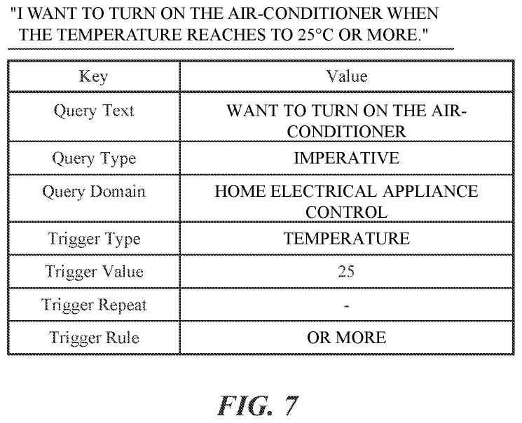

FIG. 7 is a diagram showing, together with a setting expression, a second specific example of the data structure of the registration information.

The data structure in FIG. 7 includes data that defines a query and a condition extracted from a setting expression “I want to turn on the air-conditioner when the temperature reachs to 25° C. or more.”

More specifically, the data structure in FIG. 7 includes “want to turn on the air-conditioner” as “Query Text.”

In one implementation, as the setting expression is subjected to natural language interpretation, a portion “want to turn on the air-conditioner” expressing the query is extracted from the setting expression as “Query Text.”

For example, grammar for natural language interpretation of a setting expression is stored in main server 100. Exemplary grammar is “I want to [Second Phrase] when [First Phrase].” In this grammar, each of [First Phrase] and [Second Phrase] intends to express any text. When the setting expression matches with this grammar, a portion corresponding to [First Phrase] is extracted as a portion expressing the query.

The data structure in FIG. 7 includes “imperative” as “Query Type.” In one implementation, when the setting expression does not include a phrase “want to know,” or a similar expression then “imperative” is specified as the type of the query.

The data structure in FIG. 7 includes “home electrical appliance control” as “Query Domain.” In one implementation, after the query is extracted from the setting expression, grammar to which the query applies is specified and a domain to which the specified grammar belongs is specified. Such a specified domain is specified as the value of “Query Domain.”

The data structure in FIG. 7 includes “temperature” as “Trigger Type.” In one implementation, after the query is extracted from the setting expression, a portion other than the query of the setting expression is subjected to natural language interpretation so that the value of “Trigger Type” is specified. For example, when the query includes a character string “when . . . reachs to x° C. or more” (“x” representing a number), “temperature” is specified as the value of “Trigger Type.”

The data structure in FIG. 7 includes “25” as “Trigger Value.” In one implementation, the value of “Trigger Value” is specified with the use of the phrase used in specifying the value of “Trigger Type.” More specifically, when the value “temperature” of “Trigger Type” is specified by inclusion of the phrase “when . . . reachs to 25° C. or more” in the setting expression, a numeric value “25” corresponding to a portion “25° C.” expressing the temperature that is included in the phrase is specified as the value of “Trigger Value.”

The data structure in FIG. 7 does not include a value of “Trigger Repeat.” This is based on the fact that the portion other than the query of the setting expression does not include a character string expressing the frequency in the example in FIG. 7.

The data structure in FIG. 7 includes “or more” as “Trigger Rule.” In one implementation, the value of “Trigger Rule” is specified with the use of the phrase used for specifying the value of “Trigger Type.” In the example in FIG. 7, since the phrase “when . . . reachs to 25° C. or more” includes “or more,” “or more” is specified as “Trigger Rule.”

### Third Specific Example of Registered Data

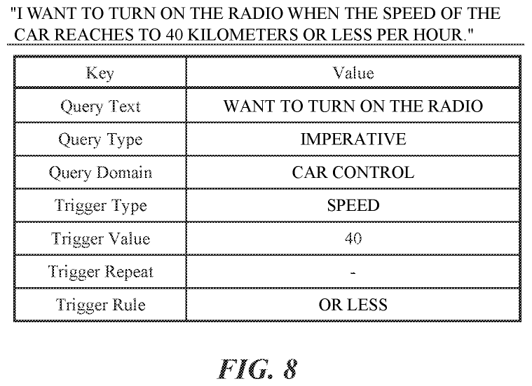

FIG. 8 is a diagram showing, together with a setting expression, a third specific example of the data structure of the registration information.

The data structure in FIG. 8 includes data that defines a query and a condition extracted from a setting expression “I want to turn on the radio when a speed of a car reachs to 40 kilometers or less per hour.”

More specifically, the data structure in FIG. 8 includes “want to turn on the radio” as “Query Text.” In one implementation, the setting expression is subjected to natural language interpretation so that a portion “want to turn on the radio” expressing the query is extracted from the setting expression as “Query Text.”

The data structure in FIG. 8 includes “imperative” as “Query Type.” In one implementation, when the setting expression does not include a phrase such as “want to know,” “imperative” is specified as the type of the query.

The data structure in FIG. 8 includes “car control” as “Query Domain.” In one implementation, after the query is extracted from the setting expression, grammar to which the query applies is specified and a domain to which the specified grammar belongs is specified. Such a specified domain is specified as the value of “Query Domain.”

The data structure in FIG. 8 includes “speed” as “Trigger Type.” In one implementation, after the query is extracted from the setting expression, a portion other than the query of the setting expression is subjected to natural language interpretation so that a value of “Trigger Type” is specified. For example, when the query includes a character string “when . . . reachs to x kilometers or less per hour” (“x” representing a number), “speed” is specified as the value of “Trigger Type.”

The data structure in FIG. 8 includes “40” as “Trigger Value.” In one implementation, the value of “Trigger Value” is specified with the use of the phrase used for specifying the value of “Trigger Type.” More specifically, when the value “speed” of “Trigger Type” is specified by inclusion of the phrase “. . . reachs to 40 kilometers or less per hour” in the setting expression, a portion “40 kilometers” (40 kilometers per hour) expressing the speed included in the phrase is specified as the value of “Trigger Type.”

The data structure in FIG. 8 does not include a value of “Trigger Repeat.” This is based on the fact that the portion other than the query of the setting expression does not include a character string expressing the frequency in the example in FIG. 8.

The data structure in FIG. 8 includes “or less” as “Trigger Rule.” In one implementation, the value of “Trigger Rule” is specified with the use of the phrase used for specifying the value of “Trigger Type.” In the example in FIG. 8, since the phrase “when . . . reachs to 40 kilometers or less per hour” includes “or less,” “or less” is specified as “Trigger Rule.”

The condition specified in the data structure shown in FIG. 8 defines that the speed per hour of the car has reached to 40 kilometers or less. In this case, the situation specified by the condition is a situation where the speed per hour of the car has reached to 40 kilometers or less and represents an exemplary situation relating to the car.

### 5. Output of Inquiry Expression Based on Condition

As described with reference to FIG. 2, interaction system 1 outputs an inquiry expression in response to occurrence of a situation specified by a condition.

In one implementation, interaction system 1 regularly collects data for determining whether or not a situation specified by a condition has occurred and determines whether or not the situation has occurred. By way of example of collection of data, main server 100 itself collects data. In another example, user terminal 200 collects data and provides the data to main server 100. More specifically, user terminal 200 provides the data to main server 100 by regularly transmitting a polling query thereto.

In connection with transmission of a polling query, main server 100 creates a frame of a polling query with the use of a part of a data group stored in storage 103 as the registration information, and transmits the frame to user terminal 200. On a regular basis, user terminal 200 generates a polling query by filling the frame with data and transmits the polling query to main server 100. A specific example of the polling query will be described below.

### First Specific Example of Polling Query and Frame Thereof

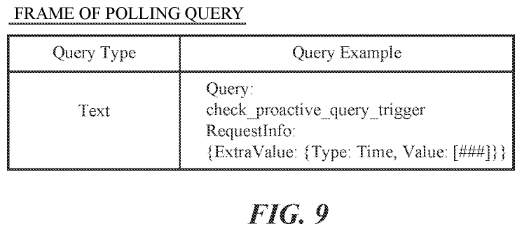

FIG. 9 is a diagram showing a first specific example of a data structure of a frame of a polling query. The example in FIG. 9 corresponds to an example where the expression shown in FIG. 6 is inputted as the setting expression.

In the example in FIG. 9, the frame of the polling query includes a message “check proactive query trigger” and a character string “RequestInfo:{ExtraValue: {Type: Time, Value: [###]}}”. The message “check proactive query trigger” indicates making determination as to whether or not the situation specified by the condition in the registration information has occurred with the use of data specified by a subsequent character string. “Type: Time” in the character string “RequestInfo:{ExtraValue: {Type: Time, Value: [###]}}” expresses the type of collected data, and more specifically expresses “time.” Main server 100 sets the type specified as “Trigger Type” in the registration information as the type of data in this message. “Value: [###]” represents a portion to be filled with collected data. More specifically, “###” is replaced with collected data.

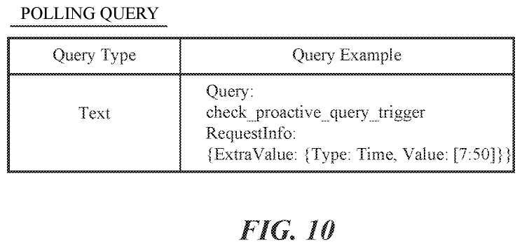

FIG. 10 is a diagram showing a first specific example of a data structure of a polling query. The data structure in FIG. 10 is generated with the use of the frame shown in FIG. 9. More specifically, the data structure in FIG. 10 is generated as user terminal 200 obtains time seven fifty as data for determining whether or not the situation specified by the condition has occurred. Further specifically, the data structure in FIG. 10 is generated by replacement of “###” in the data structure shown in FIG. 9 with the collected data “07:50” expressing time seven fifty.

As set forth above, the polling query shown in FIG. 10 indicates making determination as to whether or not the situation specified by the condition in the registration information has occurred with the use of the data expressing time “07:50”.

### Second Specific Example of Polling Query and Frame Thereof

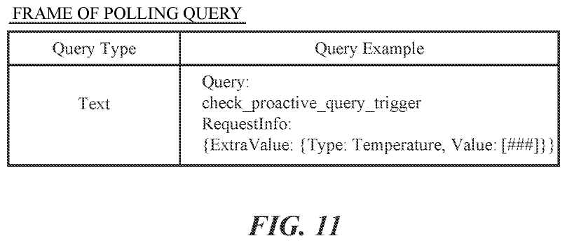

FIG. 11 is a diagram showing a second specific example of a data structure of a frame of a polling query. The example in FIG. 11 corresponds to an example where the expression shown in FIG. 7 is inputted as the setting expression.

In the example in FIG. 11, the frame of the polling query includes the message “check_proactive_query_trigger” and a character string “RequestInfo:{ExtraValue: {Type: Temperature, Value: [###]}}”. “Type: Temperature” expresses the type of collected data, and more specifically expresses “temperature.”

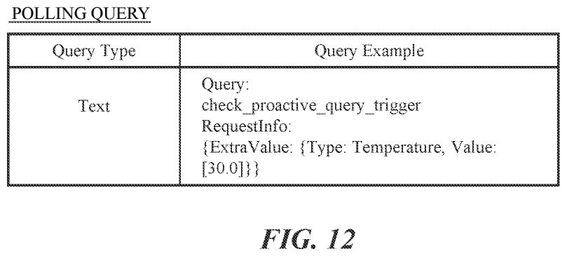

FIG. 12 is a diagram showing a second specific example of a data structure of a polling query. The data structure in FIG. 12 is generated with the use of the frame shown in FIG. 11. More specifically, the data structure in FIG. 12 is generated as user terminal 200 obtains data on the temperature 30° C. as data for determining whether or not the situation specified by the condition has occurred. User terminal 200 obtains the data, for example, by communicating with a device that measures the temperature. The data structure in FIG. 12 is generated by replacement of “###” in the data structure shown in FIG. 11 with the collected data (the temperature “30.0” expressing 30° C.).

As set forth above, the polling query shown in FIG. 12 indicates making determination as to whether or not the situation specified by the condition in the registration information has occurred with the use of the data expressing the temperature “30.0”.

### Third Specific Example of Polling Query and Frame Thereof

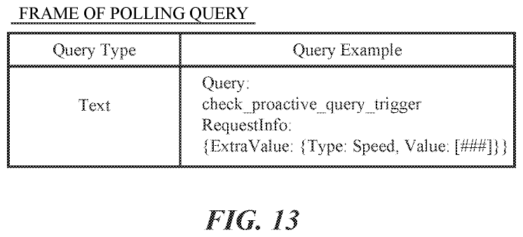

FIG. 13 is a diagram showing a third specific example of a data structure of a frame of a polling query. The example in FIG. 13 corresponds to an example where the expression shown in FIG. 8 is inputted as the setting expression.

In the example in FIG. 13, the frame of the polling query includes the message “check_proactive_query_trigger” and a character string “RequestInfo:{ExtraValue: {Type: Speed, Value: [###]}}”. “Type: Speed” expresses the type of collected data, and more specifically, expresses “speed (of the car).”

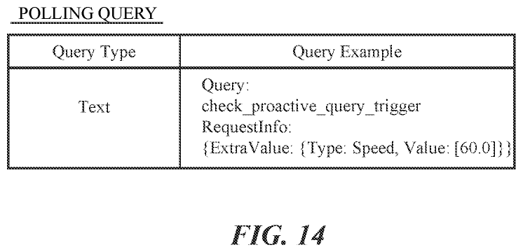

FIG. 14 is a diagram showing a third specific example of a data structure of a polling query. The data structure in FIG. 14 is generated with the use of the frame shown in FIG. 13. More specifically, the data structure in FIG. 14 is generated as user terminal 200 obtains data on the speed 60 kilometers per hour as data for determining whether or not the situation specified by the condition has occurred. User terminal 200 is implemented, for example, by a computer provided in a car, and obtains data on the speed by communicating with a speedometer of the car. The data structure in FIG. 14 is generated by replacement of “###” in the data structure shown in FIG. 13 with the collected data (data “60.0” expressing the speed 60 kilometers per hour).

As set forth above, the polling query shown in FIG. 14 indicates making determination as to whether or not the situation specified by the condition in the registration information has occurred with the use of data expressing the speed “60.0”.

### 6. Inquiry Expression

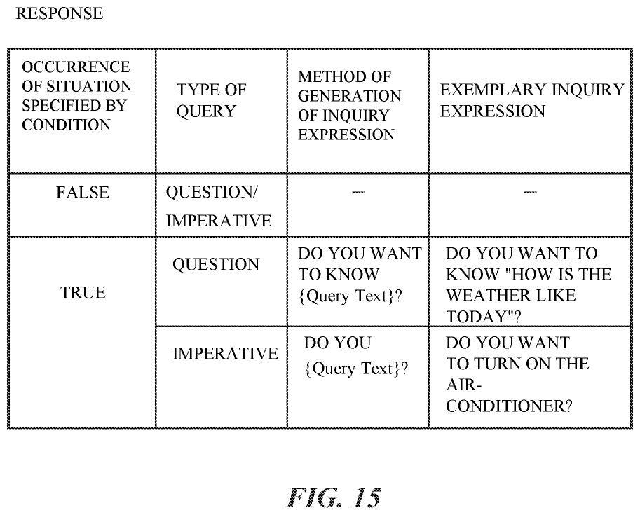

FIG. 15 is a diagram for illustrating a method of generating an inquiry expression. An exemplary method of generating an inquiry expression including a query will be described with reference to FIG. 15.

A table shown in FIG. 15 includes an item Occurrence of Situation Specified by Condition. This item represents whether or not the situation specified by the condition has occurred. The table shown in FIG. 15 further includes three items (Type of Query, Method of Generation of Inquiry Expression, and Exemplary Inquiry Expression).

When the situation has not occurred (a value of the item Occurrence of Situation Specified by Condition is expressed as “FALSE”) in the example in FIG. 15, no inquiry expression is generated regardless of the type of the query.

When the situation has occurred (the value of the item Occurrence of Situation Specified by Condition is expressed as “TRUE”) in the example in FIG. 15, the inquiry expression is generated in a manner (generation method) in accordance with the type of the query. More specifically, when the type of the query falls under “question”, the inquiry expression is generated by adding “do you want to know” to text of the query registered as the value of “Query Text” in the registration information. When the type of the query falls under “imperative”, the inquiry expression is generated by adding “do you” to text of the query registered as the value of “Query Text” in the registration information. In other words, depending on the type of the query, a character string (content) added to the text of the query for generating the inquiry expression is different.

An exemplary inquiry expression generated at the time when the type of the query falls under “question” is “do you want to know ‘how is the weather like today’?” This inquiry expression corresponds to the example shown in FIG. 6. In the example in FIG. 6, the text of the query is “how is the weather like today” and the type of the query falls under “question”. By addition of “do you want to know” to “how is the weather like today,” the above inquiry expression is generated.

An exemplary inquiry expression generated at the time when the type of the query falls under “imperative” is “do you want to turn on the air-conditioner?” This inquiry expression corresponds to the example shown in FIG. 7. In the example in FIG. 7, the text of the query is “want to turn on the air-conditioner” and the type of the query falls under “imperative”. By addition of “do you” to “want to turn on the air-conditioner,” the above inquiry expression is generated.

The generated inquiry expression may be a question that requests user 300 to give an answer meaning affirmative (for example, “YES”) or an answer meaning negative (for example, “NO”).

### 7. Flow of Process

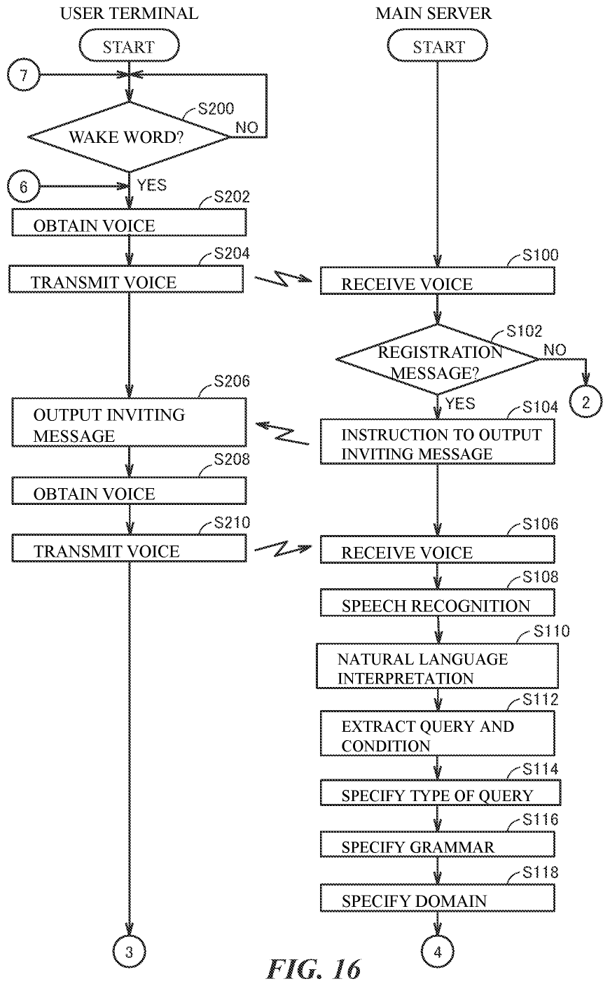

FIGS. 16 to 19 are flowcharts of processing performed by interaction system 1. FIGS. 16 to 19 show processing performed in main server 100 and processing performed in user terminal 200. In one implementation, main server 100 performs the processing by having CPU 101 execute the server app. In one implementation, user terminal 200 performs the processing by having CPU 201 execute the terminal app.

Referring to FIG. 16, in step S200, user terminal 200 determines whether or not user 300 has inputted a wake word. User terminal 200 repeats control in step S200 (NO in step S200) until it determines that the user has inputted the wake word, and when it determines that the user has inputted the wake word (YES in step S200), control proceeds to step S202.

In step S202, user terminal 200 obtains voice inputted next to the wake word from user 300.

In step S204, user terminal 200 transmits the voice obtained in step S202 to main server 100.

In step S100, main server 100 receives the voice transmitted from user terminal 200 in step S204.

In step S102, main server 100 determines whether or not the voice received in step S100 includes a message (a registration message) requesting registration of the registration information described above. The registration message represents an exemplary “specific message” in the present disclosure. An exemplary registration message is “set a query and condition.” In one implementation, main server 100 generates text of the voice with the use of speech recognition, and depending on whether or not the text includes text of the registration message, it makes determination in step S102. When main server 100 determines that the voice includes the registration message, control proceeds to step S104 (YES in step S102), and otherwise, control proceeds to step S138 (NO in step S102).

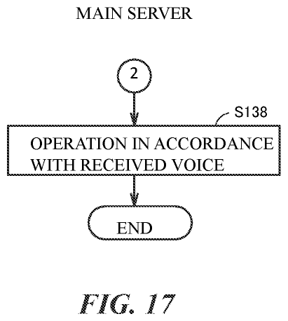

Referring to FIG. 17, in step S138, main server 100 performs an operation in accordance with the received voice and ends the process.

Referring back to FIG. 16, in step S104, main server 100 instructs user terminal 200 to output a message (an inviting message) for inviting the user to input a setting expression. An exemplary inviting message is “what's the query and the condition.”

In step S206, user terminal 200 outputs the inviting message in accordance with the instruction in step S104. An exemplary output of the inviting message is utterance of voice expressing the inviting message.

In step S208, user terminal 200 obtains voice inputted from user 300. The inputted voice is an utterance by user 300 after the output of the inviting message, and it is normally a setting expression.

In step S210, user terminal 200 transmits the voice obtained in step S208 to main server 100.

In step S106, main server 100 receives the voice transmitted in step S210.

In step S108, main server 100 subjects the voice received in step S106 to speech recognition. Text corresponding to the voice is thus obtained.

In step S110, main server 100 subjects the text obtained in step S108 to natural language interpretation.

In step S112, main server 100 extracts the query (the value of “Query Text”) and the condition (the value of each of “Trigger Type,” “Trigger Value,” “Trigger Repeat,” and “Trigger Rule”) from the setting expression (the voice inputted in step S208) with the use of a result of natural language interpretation in step S110.

In step S114, main server 100 specifies the type of the query (the value of “Query Type”) based on the setting expression (the voice inputted in step S208).

In step S116, main server 100 specifies grammar to which the query corresponds based on the setting expression (the voice inputted in step S208).

In step S118, main server 100 specifies the domain of the query (the value of “Query Domain”) based on the grammar specified in step S116.

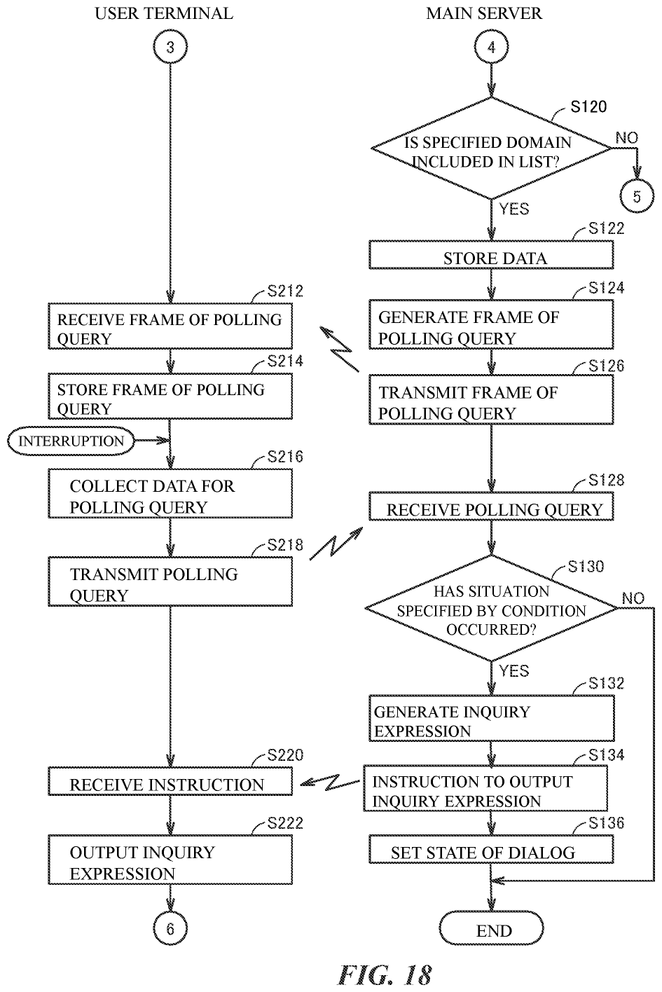

Referring to FIG. 18, in step S120, main server 100 determines whether or not the domain specified in step S118 is included in a list. The list means a list of domains applicable to user 300. In one implementation, the list is stored in storage 103. When main server 100 determines that the domain is included in the list (YES in step S120), control proceeds to step S122. When main server 100 determines that the domain is not included in the list (NO in step S120), control proceeds to step S140.

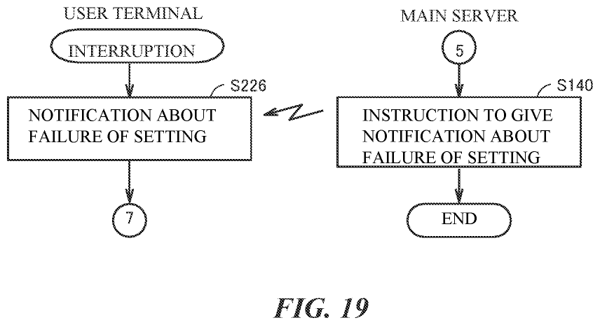

Referring to FIG. 19, in step S140, main server 100 instructs user terminal 200 to give a notification about failure of setting. Thereafter, main server 100 ends the process.

In step S226, user terminal 200 gives the notification about failure of setting in accordance with the instruction in step S140. An exemplary notification about failure of setting is output of a message “the query is not applicable.” Another exemplary notification is output of a message “please input another query.”

Referring back to FIG. 18, in step S122, main server 100 has data extracted or specified in steps S112 to S118 stored as registration information in storage 103 in association with user 300.

As described above, main server 100 determines in step S120 whether or not the domain described above is included in the list described above, and when the main server determines that the domain is not included in the list, it ends the process without having data in the registration information being stored in step S122. In this sense, step S120 is an exemplary step of avoiding registration of registration information (the query and the condition) in the memory.

In step S124, main server 100 generates the frame of the polling query with the use of the type of the query specified in step S114.

In step S126, main server 100 transmits the frame of the polling query generated in step S124 to user terminal 200.

In step S212, user terminal 200 receives the frame of the polling query transmitted in step S126.

In step S214, user terminal 200 stores the frame of the polling query received in step S212 in storage 207.

In step S216, user terminal 200 collects data for the polling query (for example, data expressed as “###” in FIG. 9, 11, or 13).

In step S218, user terminal 200 generates the polling query with the use of the data collected in step S216 and transmits the generated polling query to main server 100.

In step S128, main server 100 receives the polling query transmitted in step S218.

In step S130, main server 100 determines whether or not the situation specified by the condition in the registration information has occurred with the use of the data included in the polling query. When main server 100 determines that the situation has occurred, control proceeds to step S132 (YES in step S130), and otherwise, the main server ends the process (NO in step S130).

An exemplary situation specified by the registration information is that it is 8 AM. When the data included in the polling query expresses seven fifty AM, it is not yet 8 AM and main server 100 determines that the situation has not occurred. When the data included in the polling query expresses 8:00 AM, main server 100 determines that the situation has occurred.

Another exemplary situation specified by the registration information is that the temperature has reached to 25° C. or more. When the data included in the polling query expresses the temperature 20° C., main server 100 determines that the situation has not occurred. When the data included in the polling query expresses the temperature 30° C., main server 100 determines that the situation has occurred.

Yet another exemplary situation specified by the registration information is that the speed of the car has reached to 40 kilometers or less per hour. When the data included in the polling query expresses that the speed of the car is 60 kilometers per hour, main server 100 determines that the situation has not occurred. When the data included in the polling query expresses that the speed of the car is 30 kilometers per hour, main server 100 determines that the situation has occurred.

In step S132, main server 100 generates the inquiry expression with the use of the registration information.

In step S134, main server 100 instructs user terminal 200 to output the inquiry expression generated in step S132.

In step S136, main server 100 updates a state of dialog with user 300 in storage 103, with the use of the inquiry expression. Even when the answer from user 300 to the inquiry expression includes only contents meaning affirmative or negative, main server 100 can perform an operation in accordance with the contents of the answer from user 300 by referring to the updated state of dialog. Thereafter, main server 100 ends the process.

In step S220, user terminal 200 receives the instruction in step S134.

In step S222, user terminal 200 outputs the inquiry expression and control returns to step S202 (FIG. 16).

In the process described with reference to FIGS. 16 to 19, on a regular basis, user terminal 200 collects data in step S216 and transmits the polling query in step S218.

### 8. Specific Exemplary Operation in Interaction System 1

In the process described with reference to FIGS. 16 to 19, main server 100 obtains the setting expression and has the registration information obtained from the setting expression stored in storage 103. Then, when the situation specified by the condition in the registration information occurs, in step S134, main server 100 instructs user terminal 200 to output the inquiry expression including the query in the registration information. In response, in step S222, user terminal 200 outputs the inquiry expression. Thereafter, when user terminal 200 obtains the answer to the inquiry expression via voice in step S202, in step S204, user terminal 200 transmits the voice to main server 100. In step S100, main server 100 receives the voice, and in step S138, main server 100 performs an operation in accordance with the voice.

Through the processing described above, the user provides to the server as the setting expression, the query expressing desire for output as the inquiry expression and the condition for specifying timing at which output of the inquiry expression is desired, so that the user can be provided with a proactive operation by output of the inquiry expression including the query on the occurrence of the situation specified by the condition.

An exemplary specific operation in interaction system 1 will be described below.

### First Specific Example of Operation

An operation in an example where the registration information shown in FIG. 6 is stored will be described as a first specific example of operations in interaction system 1.

According to the example in FIG. 6, user terminal 200 regularly transmits data on time as the polling query. Main server 100 determines whether or not time included in the polling query is 8 AM, and when main server 100 determines that it is 8 AM, it instructs user terminal 200 to output the inquiry expression. In accordance with issuance of the instruction to user terminal 200 to output the inquiry expression, main server 100 may have a date of issuance of the instruction stored in storage 103. When main server 100 determines that the time included in the polling query is 8 AM, on condition that the date of that day has not yet been stored in storage 103, main server 100 may instruct user terminal 200 to output the inquiry expression.

“Do you want to know ‘how is the weather like today’?” is outputted as the inquiry expression. When user 300 gives an answer “YES” to this inquiry expression, main server 100 performs an operation in accordance with this answer. More specifically, when main server 100 accepts a positive answer “YES”, it refers to the state of dialog stored in step S136. The state of dialog is, for example, information indicating that the query registered as “Query Text” is outputted. Then, in response to acceptance of the positive answer, main server 100 processes the query registered as “Query Text.” Specifically, in order to process the query “how is the weather like today?,” main server 100 inquires of weather forecast API server 800 about the weather forecast of a region registered in association with user 300. Then, the main server obtains an answer from weather forecast API server 800 and instructs user terminal 200 to output the answer.

When user 300 speaks a negative answer “NO”, main server 100 may instruct user terminal 200 to output a specific message such as “OK”.

After the state of dialog is stored in step S136, main server 100 may erase the state of dialog from storage 103 in response to processing of the query as above or satisfaction of a given condition. An exemplary given condition is lapse of a certain period since storage of the state of dialog. Another exemplary given condition is that the voice received in step S100 after storage of the state of dialog in step S136 is a message other than the message expressing the positive answer.

As set forth above, interaction system 1 outputs the inquiry expression “do you want to know ‘how is the weather like today’?” to user 300 at eight every day. Then, when user 300 answers “YES”, interaction system 1 provides user 300 with the answer from weather forecast API server 800.

### Second Specific Example of Operation

An operation in an example where the registration information shown in FIG. 7 is stored will be described as a second specific example of operations in interaction system 1.

According to the example in FIG. 7, user terminal 200 regularly transmits data on the temperature as the polling query. In one implementation, user terminal 200 obtains the data on the temperature by communicating with a device that measures the temperature in a room associated with user 300. Main server 100 determines whether or not the temperature included in the polling query is 25° C. or more, and when main server 100 determines that the temperature is or more, it instructs user terminal 200 to output the inquiry expression. In accordance with issuance of the instruction to user terminal 200 to output the inquiry expression, main server 100 may have time of issuance of the instruction stored in storage 103. When main server 100 determines that the temperature included in the polling query is 25° C. or more, on condition that a certain period has elapsed since time of storage in storage 103, it may instruct user terminal 200 to output the inquiry expression.

“Do you want to turn on the air-conditioner?” is outputted as the inquiry expression. When user 300 gives an answer “YES” to this inquiry expression, main server 100 performs an operation in accordance with this answer. More specifically, when main server 100 accepts the positive answer “YES”, it refers to the state of dialog stored in step S136. The state of dialog is, for example, information indicating that the query registered as “Query Text” is outputted. Then, in response to acceptance of the positive answer, main server 100 processes the query registered as “Query Text.” Specifically, in order to process the query “want to turn on the air-conditioner,” main server 100 instructs control server 900 for home electrical appliance control to turn ON the air-conditioner registered in association with user 300.

As set forth above, when the temperature of the room associated with user 300 is 25° C. or more, interaction system 1 outputs the inquiry expression “do you want to turn on the air-conditioner” to user 300. Then, when user 300 gives an answer “YES”, interaction system 1 turns on the air-conditioner associated with user 300 by means of control server 900.

### Third Specific Example of Operation

An operation in an example where the registration information shown in FIG. 8 is stored will be described as a third specific example of operations in interaction system 1.

According to the example in FIG. 8, user terminal 200 regularly transmits data on the speed of a car as the polling query. In one implementation, user terminal 200 obtains the data on the speed of the car by communicating with a device that measures the speed of a vehicle associated with user 300. Main server 100 determines whether or not the speed included in the polling query is 40 km/h or less, and when the main server determines that the speed is 40 km/h or less, it instructs user terminal 200 to output the inquiry expression.

“Do you want to turn on the radio?” is outputted as the inquiry expression. When user 300 gives an answer “YES” to this inquiry expression, main server 100 performs an operation in accordance with this answer. More specifically, when main server 100 accepts the positive answer “YES”, it refers to the state of dialog stored in step S136. The state of dialog is, for example, information indicating that the query registered as “Query Text” is outputted. Then, in response to acceptance of the positive answer, main server 100 processes the query registered as “Query Text.” Specifically, in order to process the query “want to turn on the radio,” main server 100 instructs control server 900 for car control to turn ON the radio of the vehicle registered in association with user 300.

As set forth above, when the speed of the car associated with user 300 is 40 km/h or less, interaction system 1 outputs the inquiry expression “do you want to turn on the radio?” to user 300. Then, when user 300 gives an answer “YES”, interaction system 1 turns on the radio of the car associated with user 300 by means of control server 900.

### 9. Modification

Though both of the setting expression and the inquiry expression are in a form of the voice in the embodiment described above, the form is not limited to voice interaction. The setting expression may be inputted to user terminal 200 as text. In this case, user terminal 200 transmits inputted text to main server 100. The setting expression may directly be inputted to main server 100 without user terminal 200 being interposed. The inquiry expression may also be outputted as text.

In the embodiment described above, interaction system 1 recognizes the registration message in steps S202, S204, S100, and S102 before it obtains the setting expression, and thereafter in step S206, it outputs an urging message. User 300, however, may utter the registration message and the setting expression as a series of voices. After interaction system 1 recognizes the registration message, it may handle an immediately following expression as the setting expression. In this case, output of the urging message is not required.

In interaction system 1, the query and the condition are extracted from the setting expression based on natural language interpretation of the setting expression. Interaction system 1, however, may have a user interface shown (for example, on display 202), the user interface including a plurality of fields for input of the query and the condition. Interaction system 1 may obtain data inputted by user 300 in each of the plurality of fields. Interaction system 1 can thus obtain the registration information as shown in each of FIGS. 6 to 8 without making natural language interpretation of the setting expression.

In the embodiment described above, at least two users may be assumed for interaction system 1. In storage 103, registration information corresponding to each of the at least two users may be stored in association with each user. The process described with reference to FIGS. 16 to 19 may be performed for each user. In one implementation, there are a plurality of user terminals 200 in interaction system 1 and each user terminal 200 transmits information, together with a user ID of each user, to main server 100. Main server 100 identifies a user of interest of processing based on the user ID included in information transmitted from user terminal 200. Main server 100 may specify as a list to be used for determination in step S120, a list based on the user ID transmitted from user terminal 200, among at least two lists.

It should be understood that each embodiment disclosed herein is illustrative and non-restrictive. The scope of the present invention is defined by the terms of the claims rather than the description above and is intended to include any modifications within the scope and meaning equivalent to the terms of the claims. The invention described in the embodiment and each modification is intended to be carried out alone or in combination as much as possible.

1. A method of query processing comprising:
obtaining a setting expression including a query and a condition;
storing the query and the condition in a memory; and
starting a proactive interaction with an inquiry expression including the query in response to occurrence of a situation specified by the condition.

2. The method according to claim 1, further comprising extracting the query and the condition from the setting expression by natural language interpretation of the setting expression.

3. The method according to claim 1, wherein the obtaining a setting expression includes receiving voice corresponding to the setting expression.

4. The method according to claim 1, further comprising obtaining an input of a specific message, wherein accepting the setting expression is performed in response to obtaining the specific message.

5. The method according to claim 1, further comprising:
identifying grammar with which the query matches by natural language interpretation of the query;
identifying a domain to which the grammar belongs;
determining whether the domain is registered in a list stored in the memory; and
avoiding registration of the query and the condition in the memory in response to the domain not being registered in the list.

6. The method according to claim 5, wherein
the obtaining a setting expression includes receiving information that specifies a user corresponding to the setting expression among at least two users,
the list is associated with information that specifies at least one user among the at least two users, and
the determining whether the domain is registered in a list includes:
specifying a user corresponding to the setting expression on which the domain is based, and
specifying the list associated with the user.

7. The method according to claim 1, further comprising:
specifying a type of the query based on the setting expression; and
generating the inquiry expression based on the type.

8. The method according to claim 7, wherein the type identifies contents to be added to the query in the inquiry expression.

9. The method according to claim 1, wherein the inquiry expression includes a question that requests an answer meaning affirmative or negative.

10. The method according to claim 1, wherein the situation includes a situation relating to a vehicle.

11. The method according to claim 1, wherein the condition defines a frequency of occurrence of the situation.

12. A method of query processing comprising:
obtaining, by a server, a setting expression including a query and a condition;
storing, by the server, the query and the condition in a memory;
instructing, by the server, a terminal to output an inquiry expression including the query in response to occurrence of a situation specified by the condition; and
outputting, by the terminal, the inquiry expression in accordance with an instruction from the server.

13. The method according to claim 12, further comprising:
receiving, by the terminal, the setting expression via voice; and
transmitting, by the terminal, the setting expression to the server.

14. The method according to claim 12, further comprising transmitting, by the terminal to the server, data for determination as to whether the situation specified by the condition has occurred.

15. (canceled)

16. A system comprising:
memory storing instructions that are executable; and
one or more processing devices to execute the instructions to perform operations comprising:
obtaining a setting expression including a query and a condition;
storing the query and the condition in a memory; and
starting a proactive interaction with an inquiry expression including the query in response to occurrence of a situation specified by the condition.

17. The system of claim 16, wherein the operations further comprise:
identifying grammar with which the query matches by natural language interpretation of the query;
identifying a domain to which the grammar belongs;
determining whether the domain is registered in a list stored in the memory; and
avoiding registration of the query and the condition in the memory in response to the domain not being registered in the list.

18. The system of claim 16, wherein the operations further comprise:
identifying one or more of a query type, a query domain, a trigger type, a trigger value, a trigger repeat, and a trigger rule of the query.

19. The system of claim 18, wherein trigger type is extracted via natural language interpretation.

20. The system of claim 16, wherein the condition defines a frequency of occurrence of the situation.

21. The system of claim 16, wherein the obtaining a setting expression includes receiving voice corresponding to the setting expression.
